(19) United States
(12) Patent Application Publication
(10) Pub. No.: US 2024/0320509 A1
(43) Pub. Date: Sep. 26, 2024

(54) PROCESS FOR CONTROLLING CONTINUOUSLY LEARNING MODELS

(71) Applicant: GE Precision Healthcare LLC, Waukesha, WI (US)

(72) Inventor: Heikki Paavo Aukusti Väänänen, Espoo (FI)

(21) Appl. No.: 18/612,275

(22) Filed: Mar. 21, 2024

Related U.S. Application Data
(60) Provisional application No. 63/491,889, filed on Mar. 23, 2023.

(51) Int. Cl. G06N 3/096

(52) U.S. Cl. CPC G06N 3/096

(57) ABSTRACT

The subject disclosure relates generally to a method of controlling advancement of a continuous learning model as new versions of the model are generated through the continuous learning process. an update component that updates an original algorithm to a new algorithm based on expert analysis of an outcome of the original algorithm; and an execution component that runs both new and original algorithms together against unlabeled data, wherein outcome differences between the new and original algorithms are raised for expert review; and a comparison component that compares new and original model algorithm performances by evaluating counts corresponding to when each of the respective new or original algorithms are correct and when their outputs are similar to determine if a new model should replace an original model.

### CROSS-REFERENCE TO RELATED APPLICATIONS

This application claims priority to and the benefit of U.S. Provisional Patent Application Ser. No. 63/491,889, filed Mar. 23, 2023, and entitled “METHODS OF CONTROLLING ADVANCEMENT OF A CONTINUOUS LEARNING MODEL,” the entirety of which application is incorporated by reference herein.

### TECHNICAL FIELD

The subject disclosure relates generally to controlling advancement of a continuous learning model as new versions of the model are generated through a continuous learning process.

### BACKGROUND

Continuous Learning Algorithms (CLA) are a type of machine learning algorithm that are designed to learn and adapt continuously over time as new data becomes available. These algorithms are particularly useful in scenarios where data is continually changing or evolving, such as in the case of streaming data or online (online does not imply a need for connectivity to the internet, a CLA can also run on a cloud platform, a local network or even run in an isolated device, which has a local interface for collecting expert feedback) machine learning applications. The terms Artificial Intelligence (AI), Machine learning (ML) and CLA (Continuous learning algorithms—an algorithm type that continues learning after it's initial release) will be used throughout this document.

There are several features of continuous learning algorithms that distinguish them from other types of machine learning algorithms. They are designed to be incremental in nature, meaning that they update respective models in real-time as new data is received. This allows the algorithm to learn from new data points as generated, rather than waiting until a large batch of data is available.

Also, continuous learning algorithms are typically designed to be adaptable, meaning that they can adjust models in response to changes in data distribution or other environmental factors. This is important because data distribution may change over time, and the algorithm should be able to adapt to such changes in order to continue to render accurate predictions.

Additionally, continuous learning algorithms are often designed to be scalable, meaning that they can handle large amounts of data and can be distributed across multiple machines or nodes. This is significant because the amount of data generated in many applications can be voluminous, and it may be necessary to distribute processing across multiple machines in order to keep up with data flow. A challenge with a CLA is that there is no guarantee that they will learn the right content. This is especially challenging in areas where high accuracy and reliable performance is required, for example in medicine where a CLA needs to be controlled.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate the controlling of a continuous learning model are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an update component that updates an original algorithm to a new algorithm based on expert (an expert defined as a mechanism that can provide reliable (enough) info of the correct outcome; it can refer to a human subject matter expert, but it can also refer to some other devise or algorithm (artificial expert), which are likely to provide correct results. These experts may or may not require some additional information, which isn't available to the original algorithm, to enable these reference level annotations analysis of an outcome of the original algorithm update component that updates an original algorithm to a new algorithm based on expert analysis of outcome of the original algorithm. In various aspects, the computer-executable components can comprise an execution component that runs both new and original algorithms together against unlabeled data and selected samples, wherein outcome differences between the new and original algorithms are raised for expert review. In an additional embodiment, a computer-executable component can comprise a comparison component that compares new and original model algorithm performances by evaluating counts corresponding to when each of the respective new or original algorithms are correct and when their outputs are similar to determine if a new model should replace an original model.

According to one or more embodiments, a computer program product for facilitating control of a continuous learning algorithm can comprise a non-transitory computer-readable memory having program instructions embodied therewith. In various aspects, the program instructions can be executable by a processor to cause the processor to update an original algorithm to a new algorithm based on expert analysis of an outcome of the original algorithm. In various instances, the program instructions can be further executable to by a processor to cause the processor to run both new and original algorithms together against unlabeled data and selected samples, wherein outcome differences between the new and original algorithms are raised for expert review. In addition, the program instructions can be executable by the processor to cause the processor to compare new and original model algorithm performance by evaluating counts corresponding to when each of the respective new or original algorithms are correct and when their outputs are similar to determine if a new model should replace an original model.

### DESCRIPTION OF THE DRAWINGS

FIG. 1 illustrates a block diagram of an example, non-limiting system that facilitates a process of controlling a continuous learning algorithm with one or more embodiments described herein.

FIG. 2 illustrates a flow chart (part 1) of a process controlling a continuous learning algorithm in accordance with one or more embodiments described herein.

FIG. 3 illustrates a flow chart (part 2) of a process controlling a continuous learning algorithm in accordance with one or more embodiments described herein.

FIG. 4 illustrates an example, non-limiting block diagram of potential applications in accordance with one or more embodiments described herein.

FIG. 5 illustrates a block diagram of an example, non-limiting operating environment in which one or more embodiments described herein can be facilitated.

FIG. 6 illustrates an example networking environment operable to execute various implementations described herein.

### DETAILED DESCRIPTION

The following detailed description of example embodiments refers to the accompanying drawings. The same reference numbers in different drawings may identify the same or similar elements. The foregoing disclosure provides illustration and description, but is not intended to be exhaustive or to limit the implementations to the precise form disclosed. Modifications and variations are possible in light of the above disclosure or may be acquired from practice of the implementations. As used herein, the term “component” is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, operation and behavior of the systems and/or methods are described herein without reference to specific software code it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more” or “at least one.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” “includes,” “includes,” “including,” “comprises,” “comprising,” or the like are intended to be open-ended terms. Further, the phrase “based on” is intended to mean “based, at least in part, on” unless explicitly stated otherwise. References to “one embodiment” of the present invention are not intended to be interpreted as excluding the existence of additional embodiments that also incorporate the recited features. The terms “first,” “second,” and “third,” etc. are used merely as labels, and are not intended to impose numerical requirements or a particular positional order on their objects.

An artificial intelligence (AI) continuously learning algorithm is a specific type of machine learning algorithm that is designed to continuously adapt and improve its performance over time as it interacts with new data.

AI continuously learning algorithms are significant in building intelligent systems that can operate in dynamic and evolving environments, such as autonomous vehicles, personalized recommendation systems, natural language processing applications, and smart assistants.

Key characteristics of AI continuously learning algorithms include:
Adaptability: These algorithms can adapt to changes in data distribution or underlying patterns without requiring re-training from scratch. They continuously update their models based on new observations, allowing them to stay relevant and effective over time.
Incremental Learning: AI continuously learning algorithms learn from individual data points or small batches of data in an incremental fashion. They update their models iteratively as new data becomes available, rather than processing a fixed dataset in one go.
Real-Time Learning: Many AI continuously learning algorithms are capable of learning in real-time, making decisions and updating models on the fly as data streams in. This enables them to respond quickly to changing conditions and make timely decisions.
Scalability: These algorithms are often designed to scale efficiently with large volumes of data. They can handle streaming data or large datasets without significant computational overhead.
Robustness: AI continuously learning algorithms are designed to maintain performance and reliability in the face of noisy or incomplete data, concept drift, and other challenges commonly encountered in dynamic environments.

Examples of AI continuously learning algorithms include online versions of classic machine learning algorithms like online gradient descent for training neural networks, online versions of clustering algorithms for unsupervised learning tasks, and reinforcement learning algorithms that continuously update their policies based on feedback from the environment.

Overall, AI continuously learning algorithms facilitate building AI systems that can adapt, learn, and improve performance over time, enabling them to effectively tackle real-world challenges in dynamic and evolving environments.

Adaptive models-machine learning algorithms—are becoming increasingly popular in many domains, however, algorithms that continue adapting/learning after release are challenging in areas, where high accuracy and reliable performance is required. Embodiments provide a method for controlling the learning process in on-line environment; the learning is initiated by an algorithm mistake(s) corrected by an expert and later verified by raising selected samples for further annotation. An inventive aspect is in the manner to select a limited set of samples for further expert annotation in an online system by running multiple algorithm versions at the same time and is further strengthened by utilizing an already accepted algorithm version as pseudo oracle, which is now challenged.

Machine learning algorithms are not limited to a specific type or method of execution, there can be various methods such as:
Supervised Learning Algorithms: In supervised learning, an algorithm learns from labeled training data, where each input is associated with a corresponding target output. The learning process is guided by availability of labeled examples, allowing the algorithm to learn mappings between inputs and outputs. Common algorithms include linear regression, logistic regression, decision trees, support vector machines, and neural networks.
Semi-Supervised Learning Algorithms: Semi-supervised learning algorithms are a combination of supervised and unsupervised learning approaches. They leverage both labeled and unlabeled data to improve a learning process. These algorithms are particularly useful when labeled data is scarce or expensive to obtain. Examples include self-training, co-training, and graph-based methods.
Active Learning Algorithms: Active learning algorithms interactively query a user or an oracle to obtain labels for most informative instances. Instead of passively learning from all available data, these algorithms select most relevant instances to query labels, thereby reducing labeling effort and improving learning efficiency. Common strategies include uncertainty sampling, query-by-committee, and query-by-diversity.
Reinforcement Learning Algorithms: Reinforcement learning involves making sequences of decisions in an environment to maximize cumulative rewards. A learning agent interacts with an environment, receiving feedback in the form of rewards or penalties based on its actions. Reinforcement learning algorithms aim to learn an optimal policy that maps states to actions to achieve long-term goals. Examples include Q-learning, deep Q-networks (DQN), policy gradients, and actor-critic methods.
Transfer Learning Algorithms: Transfer learning algorithms leverage knowledge gained from one domain or task to improve learning in a related but different domain or task. Instead of starting from scratch, these algorithms transfer learned representations or parameters from a source domain to a target domain, speeding up a learning process and improving generalization. Common techniques include fine-tuning, feature extraction, and domain adaptation.
Federated Learning Algorithms: Federated learning enables model training across decentralized devices or servers holding local data samples, without exchanging raw data. Models are trained locally on each device or server, and only model updates are shared and aggregated to improve the global model. This approach preserves data privacy and reduces communication costs.

These are just a few examples of controlled AI learning algorithms, each designed to address different learning scenarios and objectives.

The method for testing algorithm performance is typically done by running an algorithm against a predefined test set and by verifying that the trained algorithm meets acceptance criteria with that data set. Similar process/methodology can be used for continuously learning algorithms, where a verification process is run automatically for the new/modified algorithm version and the algorithm is required to meet original set acceptance criteria and exceed performance level of the original algorithm. There are, however, several limitations in this kind of verification methods:

The first limitation can be over-training the test data set. If the same test data is used for testing algorithm versions more than once, independence of the test set can be compromised. This can be especially significant in cases, where several versions of complex machine learning algorithm are tested against same-initially independent-test data set, and the best performing model, or models exceeding the performance of the previous model (with same test data) are continuously developed.

A second limitation can be selection criteria and annotation of the new data samples: Expert annotation of data is expensive, so the annotation process should be focused to the most important set of data. Unfortunately, selection of this kind of data is challenging and highly case dependent. This is especially significant in situations where algorithm updates are continuous requiring semi-continuous or case dependent verification of new algorithm version. An example of this kind of use case is the situation where a patient specific model is developed as part of normal hospital procedure.

A third limitation can be device technical performance limitations. The need to keep and maintain big data sets can be expensive. It requires memory to store the data, and testing algorithm versions against the big data set requires voluminous processing cycles. Accurate ML models can be complex and consume excessive computational resources e.g., computer memory, computer processing capacity, inferencing time). In particular, one learning neural network can contain hundreds, thousands, or even millions of internal parameters.

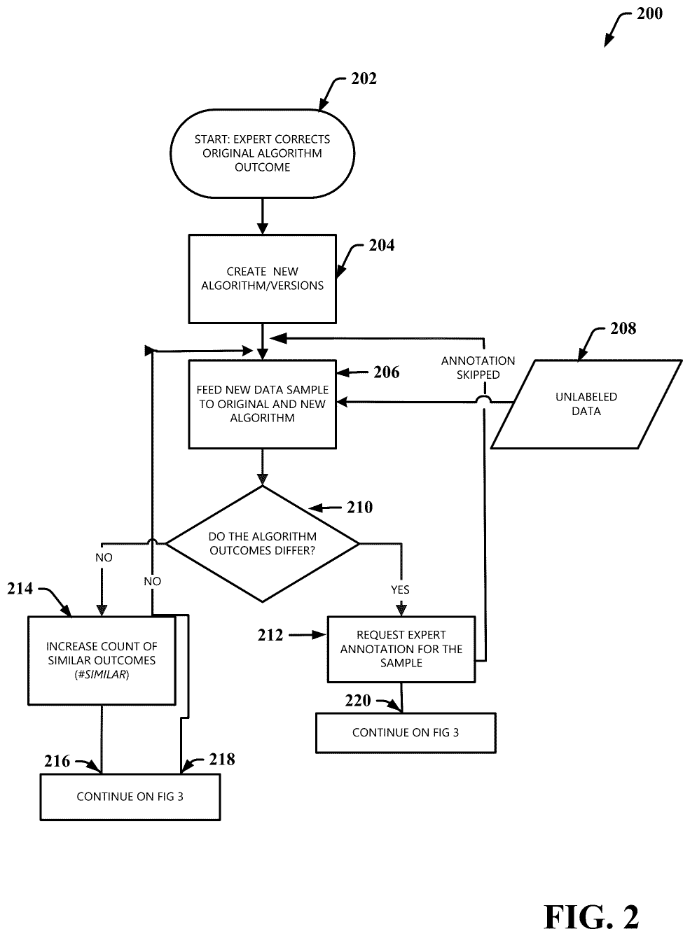

The present disclosure provides a method to address the above problems. It should be also noted that the present disclosure doesn't limit a manufacturer to utilize also other (including the ones described above) methods for verification. A novelty is this is a method to run both original and new (updated) algorithms in parallel to find samples for expert annotation, and to use these annotations for verifying upgraded algorithm performance in online system(s) to enable automated algorithm updating. Basically, the invention provides the means for selecting relevant events for verification/annotation, and it provides the means for evaluating if the new model outperforms the original/verified model. The evaluation is done by utilizing the information about algorithm accuracy in these just selected and annotated samples and by utilizing also (optionally) the total count of samples, where the algorithms gave similar outputs. The entire process will be detailed in FIGS. 2 &3. Embodiments can be used alone (when appropriate) or to strengthen other verification methods. The combined/hybrid models for verification can also enable use of lighter versions (smaller fixed test data set for example) of the individual verification procedures.

It should be appreciated that the herein figures and description provide non-limiting examples of various embodiments and are not necessarily drawn to scale.

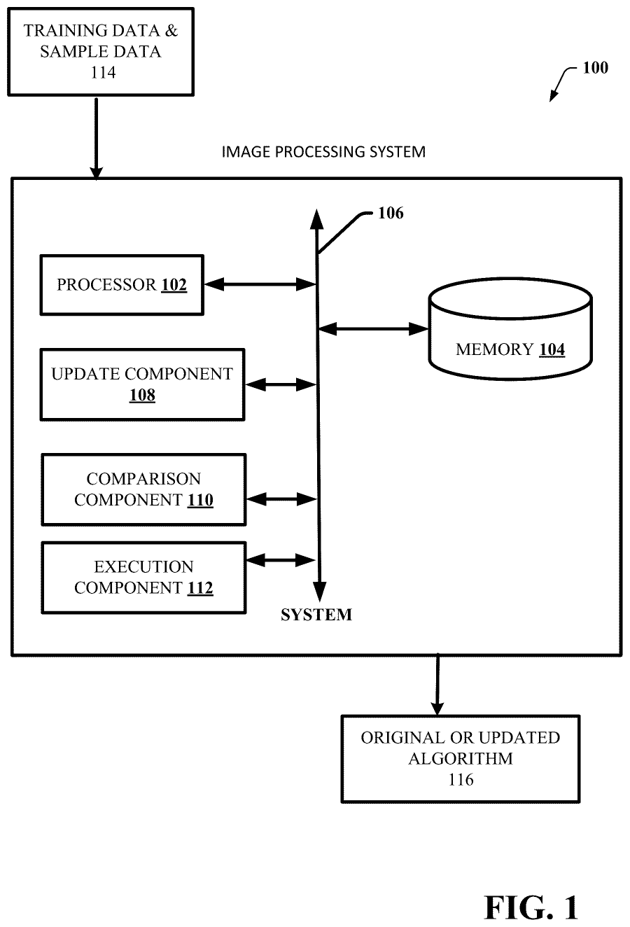

FIG. 1 illustrates a block diagram of an example, non-limiting system 100 that facilitates the process of controlling a continuous learning algorithm with one or more embodiments described herein. System 100 can comprise a processor 102, memory 104, system bus 106, an update component 108 that can update component that updates an original algorithm to a new algorithm based on expert analysis of an outcome of the original algorithm, an execution component 112 that runs both new and original algorithms together against unlabeled data and selected samples, wherein outcome differences between the new and original algorithms are raised for expert review. Also, a comparison component 110 that compares new and original model algorithm performances by evaluating counts corresponding to when each of the respective new or original algorithms are correct and when their outputs are similar to determine if a new model should replace an original model.

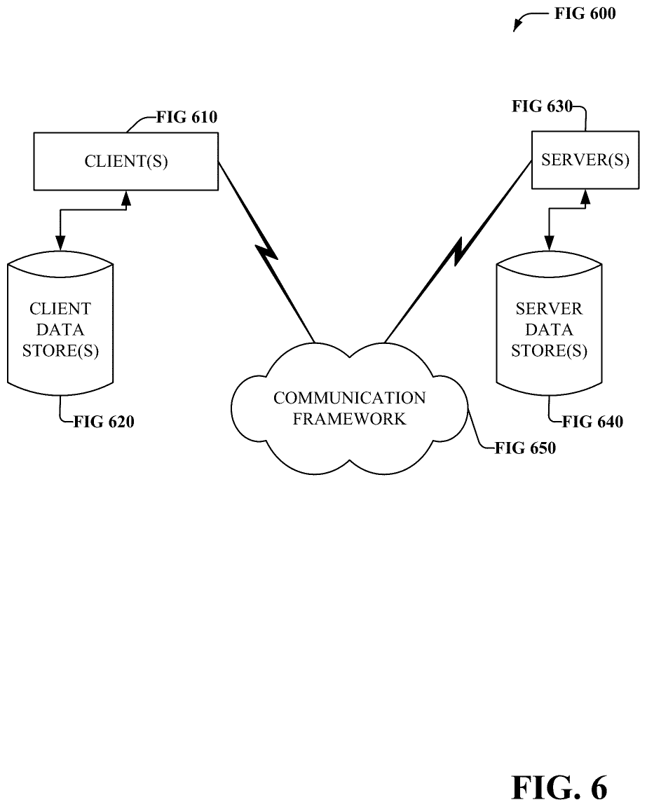

The system 100 can also include input such as training and/or sample data 114 and also possibly an output of a specific algorithm 116 based on results of an internal algorithm comparison. One or more aspects of the non-limiting system 100 can be described in conjunction with one or more embodiments in FIG. 2 thru FIG. 6.

Discussion first turns briefly to processor 102, memory 104 and bus 106 of system 100. For example, in one or more embodiments, system 100 can comprise processor 102 (e.g., computer processing unit, microprocessor, classical processor, and/or like processor). In one or more embodiments, a component associated with system 100, as described herein with or without reference to one or more figures of the one or more embodiments, can comprise one or more computer and/or machine readable, writable and/or executable components and/or instructions that can be executed by processor 102 to enable performance of one or more processes defined by such component(s) and/or instruction(s).

In one or more embodiments, system 100 can comprise a computer-readable memory (e.g., memory 104) that can be operably connected to the processor 102. Memory 104 can store computer-executable instructions that, upon execution by processor 102, can cause processor 102 and/or one or more other components of system 100 (e.g., update component 108, comparison component 110, and/or the execution component 112 to perform one or more actions. In one or more embodiments, memory 104 can store computer-executable components (e.g., update component 108, comparison component 110, and/or the execution component 112).

System 100 and/or a component thereof as described herein, can be communicatively, electrically, operatively, optically and/or otherwise coupled to one another via bus 106. Bus 106 can comprise one or more of a memory bus, memory controller, peripheral bus, external bus, local bus, and/or another type of bus that can employ one or more bus architectures. One or more of these examples of bus 106 can be employed. In one or more embodiments, system 100 can be coupled (e.g., communicatively, electrically, operatively, optically and/or like function) to one or more external systems (e.g., a non-illustrated electrical output production system, one or more output targets, an output target controller and/or the like), sources and/or devices (e.g., classical computing devices, communication devices and/or like devices), such as via a network. In one or more embodiments, one or more of the components of system 100 can reside in the cloud, and/or can reside locally in a local computing environment (e.g., at a specified location(s)).

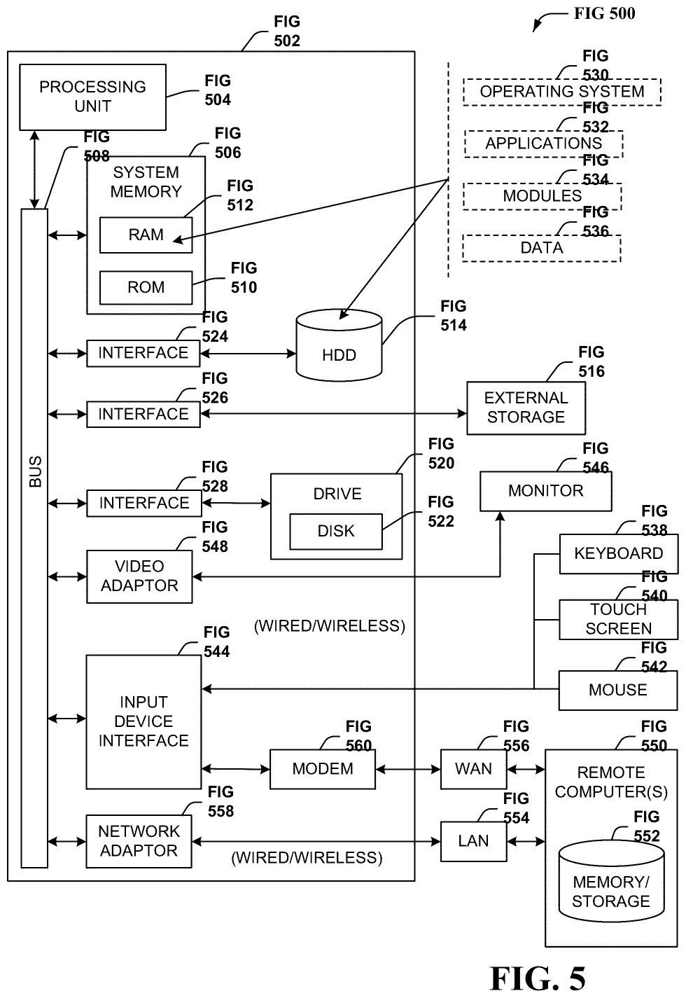

In addition to the processor 102 and/or memory 104 described above, system 100 can comprise one or more computer and/or machine readable, writable and/or executable components and/or instructions that, when executed by processor 102, can enable performance of one or more operations defined by such component(s) and/or instruction(s). System 100 can be associated with, such as accessible via, a computing environment 500 described below with reference to FIG. 5. For example, system 100 can be associated with a computing environment 500 such that aspects of processing can be distributed between system 100 and the computing environment 500.

FIG. 2 illustrates a flow chart, diagram 200 (the first half of the process) of controlling a continuous learning algorithm utilizing this innovation in accordance with one or more embodiments described herein. In various embodiments, as shown, is a method to control and/or verify performance of the systems with continuous learning algorithm or with any machine learning algorithm that can evolve after release based on data samples without additional software engineering. This method can result in cost and time savings. The process starts at 202 with an expert, that corrects outcome of an original algorithm. An expert can be a human such as a medical doctor or other medical professional or the expert could be another system. In the case where the expert is another system, the other system would have additional information data or resources in use. This can include data collected with invasive or more expensive methods, or it could be data collected at a later time. Delayed data collection can especially be true for predictive models or in cases where new medical inputs become available such as longitudinal studies, clinical trials, biopsies, other surgical procedures, or expert review.

In the medical arena, diagnostic or patient monitoring algorithms are seldom perfect; variability between patients and biases between patient populations, between recording conditions, and between clinical workflows make it very challenging to design an algorithm that would be always correct. At the same time the outcomes from the wrong analysis can have critical outcomes for the patients. CLA algorithms can provide improved accuracy by allowing clinicians to customize the medical devices by correcting their mistakes. When algorithm learns from its mistakes the patient, patient population and/or environment biases are reduced.”

The original algorithm is a verified algorithm running in an online system. The algorithm outcome can be, for example, a heartbeat or arrhythmia class given by an Electrocardiogram (ECG) algorithm in patient monitoring. An arrhythmia class typically refers to a categorization system used to classify different types of cardiac arrhythmias based on their characteristics, underlying mechanisms, and clinical significance. These classes help healthcare professionals better understand and manage arrhythmias. While there isn't a universally standardized classification system, several commonly used classifications include: by Mechanism, by Site of Origin, by Heart Rate, by Electrocardiogramce, by Clinical Significance, and by Duration. Healthcare professionals often use these classification systems to diagnose arrhythmias accurately, guide treatment decisions, and communicate effectively with other members of a healthcare team. The choice of classification system may vary depending on specific clinical context and needs of individual patients. The outcome in 202 refers to a result of an original algorithm, which is run in the device and can be the released algorithm version or a verified updated version, which has replaced the released version.

Using the expert correction 202, the original algorithm is used to create a new algorithm model/version in 204, but the original algorithm itself remains unchanged-so there are two algorithms at this point. Methods to update the algorithm aren't limited by this embodiment. Potential methods can include training methods utilizing existing databases or methods utilizing new sample(s), An example could be (for example) a KNN algorithm, which uses new expert annotated sample as an additional sample in defined feature space. This feature space could, for example consist of features extracted from an electrocardiogram (ECG), and these features could be, for example “QRS duration” (which is measured as duration of so called QRS complex) and “heart rate” (which refers to the rate how often these QRS complexes are seen. QRS complex is waveform in ECG that is produced by electrical activity of ventricles.

In 206 it can be observed that both the new and original versions of the algorithm receive an input of unlabeled data 208, and are then run together against this unlabeled data. A decision point is reached 210 in cases where the samples used result in algorithm outcome differences, these instances are raised for expert review/annotation for the sample 212. The data used can include a previously collected set of samples and samples that are later processed by a device in normal use. The use of already collected samples enables faster/immediate continuation of a verification process, however there is a potential trade off of algorithm over-learn, in the case where the same sample is used many times for testing. A benefit of the use of samples collected later during normal device operation is that this enables the collection of expert feedback during normal device operation. Another benefit of later data collection is that this embodiment does not require collection and storage of data set in device memory, if the data does not need to be stored otherwise.

Following the decision point 210 in cases where the algorithm outcome does NOT differ (No) between the new and original versions 214, meaning the results are similar, the count of the similar outcomes is increased (#similar). In an additional embodiment, counts can be made relative to when the new and old algorithm have similar outcomes, regardless if the outcomes are true or not.

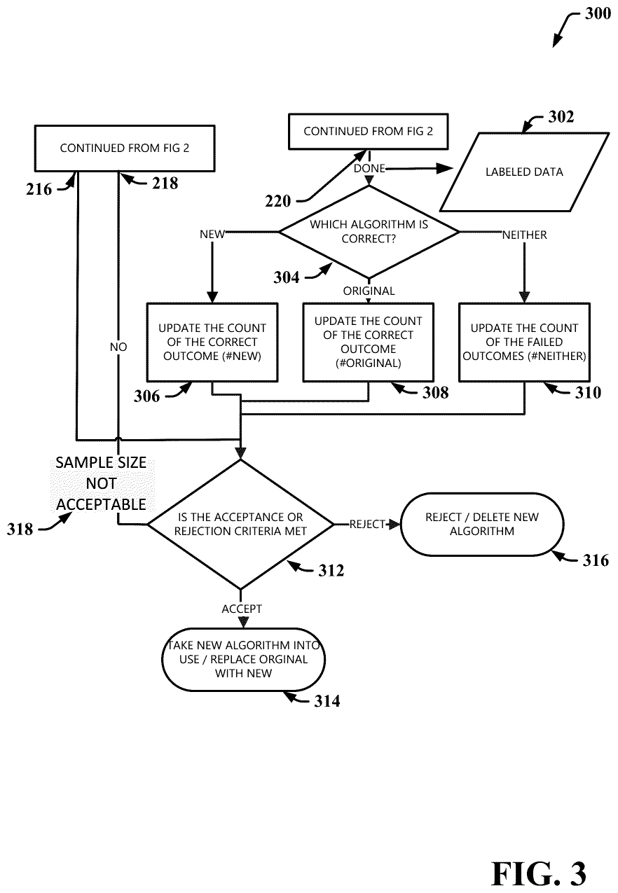

FIG. 3 illustrates a flow chart, diagram 300 (part 2), which is a continuation of 200 of the process of controlling a continuous learning algorithm based on this innovation in accordance with one or more embodiments described herein. The connections between diagrams 200 and 300 are identified as 216, 218 and 220. Expert annotation or review 212 for the sample results in an output of labeled data 302. Now an evaluation of the algorithm outcome 304 is performed and based on expert review the count of algorithm outcomes (#new, #original or #neither) is updated accordingly. The new algorithm may be correct, which results in an update of the count of the correct outcome (new) 306. The original algorithm may be correct, which results in an update of the count of the correct outcome (original) increasing 308. Finally, neither of the outcomes may be correct, resulting in an update of the failed outcomes (neither) as shown on 310.

The update isn't limited to a linear binary update (+1 to the corresponding outcome count), but it can also include non-linear means and weighting of the update based on estimated criticality/importance of the True or False Outcome. Nonlinearity in this context means that the update can be something else besides adding a constant value (like+1) to the #new, #original or #neither counts. It can be multicable, logarithmic or exponential for example. This means the “count” doesn't need to be referred to as a conventional count, but it can be updated with other monotonic means, especially, when some weighting of different use cases are utilized.

An example of a non-linear or weighting method in this kind of case 212, could be a False heartbeat detection during Asystole compared to a False heartbeat detection during normal sinus rhythm in patient monitoring. Asystole is a medical condition characterized by absence of any detectable electrical activity in the heart. In other words, it's a form of cardiac arrest where the heart stops beating and there is no measurable heart rhythm on an electrocardiogram (ECG). An incorrect heartbeat detected could prevent an asystole alarm, which is more critical than a single false beat detection during normal heart rhythm, which might result only a minor error in heart rate estimation. This could be beneficial to give more weight to the correct algorithm performance during asystole than during normal heart rhythm.

An update during expert review 212 can also include updating the annotator information if acceptance criteria requires input from more than one expert. In cases where an annotator refuses to annotate and or skip the annotation of the sample, the process is continued back to 206 from 212 with a new sample from 208 and the non-annotated sample is rejected/ignored from the process. The feedback loops indicate continuing the process with a new sample, not keeping the same data sample in flow all the time. Algorithm performances are then compared 312 by evaluating counts where each of the algorithms was correct. If performance of the new exceeds the performance of the original algorithm/model and meets pre-defined acceptance criteria (that can include other criteria outside this invention) the new replaces the original algorithm 314. If the acceptance criteria isn't met due to a low number of samples 318, the process is continued by feeding new data samples to the algorithms 206. Otherwise, the new algorithm is rejected/deleted 316. It should be noted that the comparison (and the full process) can be extended to include more than just two (original and new) algorithm versions at the same time.

Acceptance criteria 312 is the criteria used for accepting the new algorithm to replace the original algorithm. It includes the rejection criteria 314, which defines the state, where enough data samples are used for verification, but the acceptance criteria isn't met. The criteria can also include requirements to have data samples annotated by more than one expert 312.

An example of the use case where annotation by multiple Experts is required is a patient monitor, in the case where one clinician has silenced an arrhythmia or abnormal heartbeat alarm as false, and another clinician(s) with specified status is required for further alarm annotations to verify the algorithm update. An example of an acceptance criteria is then defined by the limits, where the minimum number of the tested samples (n), minimum number of the samples with different algorithm outcomes (d), and the minimum value of update improvement (p) are compared to the evaluated counts (as shown):

| | |
|---|---|
| #similar + #new + #original + #neither > n | AND |
| #new + #original + #neither > d | AND |

#new − #original) / (#new + #original) > p

The process illustrated in 200 and 300 can be used as part of normal/full verification of a new algorithm version, but it is especially designed to be used in online verification of continuously learning (machine learning) algorithm(s). A need for such process has arisen in patient monitoring, where personalized monitoring, and tuning algorithms to patient specific signals for better performance (especially for less false alarm) is actively addressed. For example, in ECG monitoring a small number of patients (<10%) are responsible for most of the alarms (>80%), and patient specific tuning of the algorithm is highly needed. Another specific scenario in this domain are predictive algorithms, which are by default machine learning based algorithms, and where patient specific adaptability can be critical for satisfactory performance.

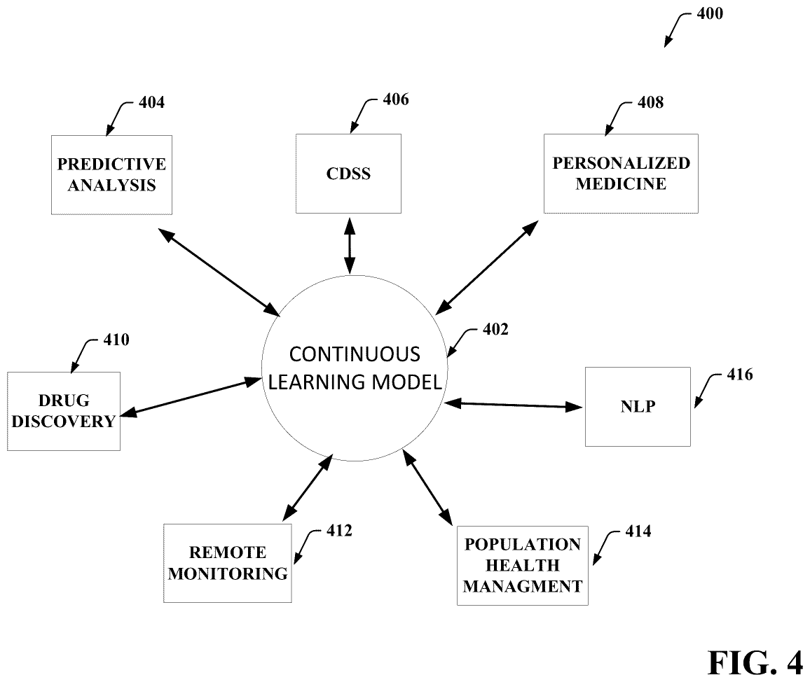

While examples in the medical domain have been discussed in regard to 200 and 300, the use cases have applicability beyond the medical domain as depicted in FIG. 4, in cases where novelty of an expert review or annotation can be used in place of software engineering to enhance algorithms.

FIG. 4 illustrates various application the innovation 402 can be possibly employed in accordance with one or more embodiments described herein.

Different areas of application include predictive analytics 404 in which continuous learning algorithms can be used to predict patient outcomes, such as readmissions, mortality rates, or the risk of developing certain diseases. These models continuously update their predictions as new patient data becomes available, allowing for more accurate and personalized risk assessments. An example in the health care area would be in which the continuous learning model within a cloud or an internal network can be utilized for single patient monitoring and recording, and predicting critical patient events or changes in patient states such as heart rate values or others. Also, areas such as Clinical Decision Support Systems (CDSS) 406, CDSS powered by continuous learning can assist healthcare providers in making more informed decisions by providing real-time recommendations based on the latest medical evidence and patient data. These systems can help improve diagnosis accuracy, treatment selection, and patient management. Personalized Medicine 408 can benefit from continuous learning models as they can analyze large datasets, including genomic data, electronic health records, and patient-reported outcomes, to tailor treatments and interventions to individual patients. By continuously updating their algorithms with new patient data and medical research findings, these models can refine their recommendations over time. Drug Discovery and Development 410 is another area in which continuous learning algorithms can accelerate the drug discovery process by analyzing vast amounts of biomedical data, including chemical structures, biological pathways, and clinical trial results. These models can identify potential drug candidates, predict their efficacy and safety profiles, and optimize drug designs based on ongoing feedback from experimental data. Remote Monitoring and Telemedicine 412 also can employ continuous learning models. In remote monitoring applications, continuous learning models can analyze streams of patient-generated health data, such as vital signs, activity levels, and symptoms, to detect early warning signs of health deterioration or exacerbation of chronic conditions. These models can adapt to individual patient characteristics and changing health status over time, enabling proactive interventions and timely medical interventions. Within the domain of population health management: 414 this model process of controlling Continuous learning algorithms can potentially analyze population-level data to identify trends, patterns, and risk factors that may impact public health outcomes. These models can help healthcare organizations develop targeted interventions and allocate resources more effectively to improve overall population health and reduce disparities. In the scope of natural language processing (NLP) 414, NLP models trained with continuous learning techniques can extract valuable insights from unstructured clinical text, such as medical notes, imaging reports, and research articles. These models can learn from new data sources and medical literature updates to enhance their understanding of medical terminology, patient histories, and treatment outcomes. Continuous learning models in healthcare hold great promise for improving patient outcomes, enhancing clinical decision-making, and driving innovation across the healthcare ecosystem.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

In order to provide additional context for various embodiments described herein, FIG. 5 and the following discussion are intended to provide a brief, general description of a suitable computing environment 500 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 5, the example environment 500 for implementing various embodiments of the aspects described herein includes a computer 502, the computer 502 including a processing unit 504, a system memory 506 and a system bus 508. The system bus 508 couples system components including, but not limited to, the system memory 506 to the processing unit 504. The processing unit 504 can be any of various commercially available processors. Dual microprocessors and other multi-processor architectures can also be employed as the processing unit 504.

The system bus 508 can be any of several types of bus structure that can further interconnect to a memory bus (with or without a memory controller), a peripheral bus, and a local bus using any of a variety of commercially available bus architectures. The system memory 506 includes ROM 510 and RAM 512. A basic input/output system (BIOS) can be stored in a non-volatile memory such as ROM, erasable programmable read only memory (EPROM), EEPROM, which BIOS contains the basic routines that help to transfer information between elements within the computer 502, such as during startup. The RAM 512 can also include a high-speed RAM such as static RAM for caching data.

The computer 1402 further includes an internal hard disk drive (HDD) 514 (e.g., EIDE, SATA), one or more external storage devices 516 (e.g., a magnetic floppy disk drive (FDD) 516, a memory stick or flash drive reader, a memory card reader, etc.) and a drive 520, e.g., such as a solid state drive, an optical disk drive, which can read or write from a disk 522, such as a CD-ROM disc, a DVD, a BD, etc. Alternatively, where a solid state drive is involved, disk 522 would not be included, unless separate. While the internal HDD 514 is illustrated as located within the computer 502, the internal HDD 514 can also be configured for external use in a suitable chassis (not shown). Additionally, while not shown in environment 500, a solid state drive (SSD) could be used in addition to, or in place of, an HDD 514. The HDD 514, external storage device(s) 516 and drive 520 can be connected to the system bus 508 by an HDD interface 524, an external storage interface 526 and a drive interface 528, respectively. The interface 524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 512, including an operating system 530, one or more application programs 532, other program modules 534 and program data 536. All or portions of the operating system, applications, modules, or data can also be cached in the RAM 512. The systems and methods described herein can be implemented utilizing various commercially available operating systems or combinations of operating systems.

Computer 502 can optionally comprise emulation technologies. For example, a hypervisor (not shown) or other intermediary can emulate a hardware environment for operating system 530, and the emulated hardware can optionally be different from the hardware illustrated in FIG. 5. In such an embodiment, operating system 530 can comprise one virtual machine (VM) of multiple VMs hosted at computer 502. Furthermore, operating system 530 can provide runtime environments, such as the Java runtime environment or the .NET framework, for applications 532. Runtime environments are consistent execution environments that allow applications 532 to run on any operating system that includes the runtime environment. Similarly, operating system 530 can support containers, and applications 532 can be in the form of containers, which are lightweight, standalone, executable packages of software that include, e.g., code, runtime, system tools, system libraries and settings for an application.

Further, computer 502 can be enable with a security module, such as a trusted processing module (TPM). For instance with a TPM, boot components hash next in time boot components, and wait for a match of results to secured values, before loading a next boot component. This process can take place at any layer in the code execution stack of computer 502, e.g., applied at the application execution level or at the operating system (OS) kernel level, thereby enabling security at any level of code execution.

A user can enter commands and information into the computer 502 through one or more wired/wireless input devices, e.g., a keyboard 538, a touch screen 540, and a pointing device, such as a mouse 542. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 504 through an input device interface 544 that can be coupled to the system bus 508, but can be connected by other interfaces, such as a parallel port, an IEEE 1394 serial port, a game port, a USB port, an IR interface, a BLUETOOTH® interface, etc.

A monitor 546 or other type of display device can be also connected to the system bus 508 via an interface, such as a video adapter 548. In addition to the monitor 546, a computer typically includes other peripheral output devices (not shown), such as speakers, printers, etc.

The computer 502 can operate in a networked environment using logical connections via wired or wireless communications to one or more remote computers, such as a remote computer(s) 550. The remote computer(s) 550 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 552 is illustrated. The logical connections depicted include wired/wireless connectivity to a local area network (LAN) 554 or larger networks, e.g., a wide area network (WAN) 556. Such LAN and WAN networking environments are commonplace in offices and companies, and facilitate enterprise-wide computer networks, such as intranets, all of which can connect to a global communications network, e.g., the Internet.

When used in a LAN networking environment, the computer 502 can be connected to the local network 554 through a wired or wireless communication network interface or adapter 558. The adapter 558 can facilitate wired or wireless communication to the LAN 554, which can also include a wireless access point (AP) disposed thereon for communicating with the adapter 558 in a wireless mode.

When used in a WAN networking environment, the computer 502 can include a modem 560 or can be connected to a communications server on the WAN 556 via other means for establishing communications over the WAN 556, such as by way of the Internet. The modem 560, which can be internal or external and a wired or wireless device, can be connected to the system bus 508 via the input device interface 544. In a networked environment, program modules depicted relative to the computer 502 or portions thereof, can be stored in the remote memory/storage device 552. It will be appreciated that the network connections shown are example and other means of establishing a communications link between the computers can be used.

When used in either a LAN or WAN networking environment, the computer 502 can access cloud storage systems or other network-based storage systems in addition to, or in place of, external storage devices 516 as described above, such as but not limited to a network virtual machine providing one or more aspects of storage or processing of information. Generally, a connection between the computer 502 and a cloud storage system can be established over a LAN 554 or WAN 556 e.g., by the adapter 558 or modem 560, respectively. Upon connecting the computer 502 to an associated cloud storage system, the external storage interface 526 can, with the aid of the adapter 558 or modem 560, manage storage provided by the cloud storage system as it would other types of external storage. For instance, the external storage interface 526 can be configured to provide access to cloud storage sources as if those sources were physically connected to the computer 502.

The computer 502 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 6 is a schematic block diagram of a sample computing environment 600 with which the disclosed subject matter can interact. The sample computing environment 600 includes one or more client(s) 610. The client(s) 610 can be hardware or software (e.g., threads, processes, computing devices). The sample computing environment 600 also includes one or more server(s) 630. The server(s) 630 can also be hardware or software (e.g., threads, processes, computing devices). The servers 630 can house threads to perform transformations by employing one or more embodiments as described herein, for example. One possible communication between a client 610 and a server 630 can be in the form of a data packet adapted to be transmitted between two or more computer processes. The sample computing environment 600 includes a communication framework 650 that can be employed to facilitate communications between the client(s) 610 and the server(s) 630. The client(s) 610 are operably connected to one or more client data store(s) 620 that can be employed to store information local to the client(s) 610. Similarly, the server(s) 630 are operably connected to one or more server data store(s) 640 that can be employed to store information local to the servers 630.

The present invention may be a system, a method, an apparatus or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations or block diagrams of methods, apparatus (systems), and computer program products according to embodiments of the invention. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, the computer-executable components comprising:
an update component that updates an original algorithm to a new algorithm based on expert analysis of an outcome of the original algorithm; and
an execution component that runs both new and original algorithms together against unlabeled data wherein outcome differences between the new and original algorithms are raised for expert review; and
a comparison component that compares new and original model algorithm performances by evaluating counts corresponding to when each of the respective new or original algorithms are correct and when their outputs are similar to determine if a new model should replace an original model.

2. The system of claim 1, wherein improved performance of an event detection algorithm is verified by offering an expert to annotate events, wherein outputs of a trained algorithm and the original algorithm differ, and wherein a decision of taking a modified algorithm into use is based on accuracy results associated with the annotated events.

3. The system of claim 1, wherein the expert review can be from at least one of a human or system, with additional information data in use which collected with invasive methods or data collected later in time.

4. The system of claim 1, wherein events are raised for re-annotation in an on-line process for data already collected but without verified annotations.

5. The system of claim 1, wherein within a comparison, n (a number of) annotations are raised for re-annotation and a trained model needs to outperform an original model with events in scope.

6. The system of claim 1 wherein methods to update an algorithm include at least one of: training methods utilizing existing databases, or methods utilizing new sample(s) only.

7. The system of claim 1, wherein the annotations are weighted based on their estimated criticality or importance in a model selection/determination/decision process.

8. The system of claim 1, wherein acceptance criteria for either model is pre-defined with limits developed by an expert in continuous learning models.

9. The system of claim 8, wherein if the acceptance criteria is not satisfied due to low sample sizes below a defined threshold, the comparison is continued by feeding new data samples to the models.

10. A computer-implemented method, comprising:
updating, utilizing a processor operatively coupled to a memory, an original algorithm to a new algorithm based on expert analysis of an outcome of the original algorithm; and
executing, utilizing a processor, running both new and original algorithms together against unlabeled data, and selected samples, wherein outcome differences between the new and original algorithms are raised for expert review; and
comparing, utilizing a processor, algorithm performances by evaluating counts wherein each of the respective algorithms are correct and when their outputs are similar to determine if a new model should replace an original model.

11. The method of claim 10, further comprising analyzing improved performance of event detection algorithms that are verified by offering an expert to annotate events, wherein outputs of a trained algorithm and the original algorithm differ, and wherein the determination of taking a modified algorithm into use is based on accuracy results associated with the annotations.

12. The method of claim 10, further comprising the expert analysis being performed by a human or system, with additional information data in use collected with invasive methods or data collected later in time.

13. The method of claim 10, further comprising events that are raised for re-annotation in an on-line process for data already collected but without verified annotations.

14. The method of claim 10, further comprising a comparison in which n (a number of) annotations are raised for re-annotation and a trained model needs to outperform an original model with the events in scope.

15. The method of claim 10, further comprising updating an algorithm utilizing existing databases or new sample(s).

16. The method of claim 10, further comprising annotations that are weighted based on their estimated criticality or importance in a model selection/determination/decision process.

17. The method of claim 10, further comprising utilizing acceptance criteria for either model that is based on pre-defined limits developed by an expert in continuous learning models.

18. The method of claim 17, further comprising utilizing acceptance criteria that if not satisfied due to low sample sizes below a defined threshold, the comparison is continued by feeding new data samples to the models.

19. A computer program product for facilitating the control of a continuous learning model, the computer program product comprising a non-transitory computer-readable memory having program instructions embodied therewith, the program instructions executable by a processor to cause the processor to:
update an original algorithm to a new algorithm based on expert analysis of the outcome of the original algorithm; and
execute both new and original version algorithms together against un-labeled data, and selected samples, where the algorithm outcome differences are raised for expert review; and
compare the new and original model algorithm performances by evaluating the counts where each of the new or original algorithms are correct and when their outputs are similar to determine if a new model should replace an original model.

20. The computer program product of claim 19, wherein the program instructions are executable by the processor to cause the processor to analyze improved performance of event detection algorithm that is verified by offering an expert to annotate the events, where the outputs of the trained algorithm and the original algorithm differ, and where the decision of taking the modified algorithm into use is based on accuracy results with these annotations.
